(19) United States
(12) Patent Application Publication
(10) Pub. No.: US 2026/0304530 A1
(43) Pub. Date: Oct. 1, 2026

(54) METHOD AND APPARATUS FOR APPLICATION AWARE NETWORK RESOURCE MANAGEMENT

(71) Applicant: Charter Communications Operating, LLC, St. Louis, MO (US)

(72) Inventor: Pareshkumar Panchal, Highlands Ranch, CO (US)

(73) Assignee: Charter Communications Operating, LLC, St. Louis, MO (US)

(21) Appl. No.: 19/091,195

(22) Filed: Mar. 26, 2025

(51) Int. Cl. H04W 76/19; H04B 17/309; H04W 24/10; H04W 56/00

(52) U.S. Cl. CPC H04W 76/19; H04B 17/346; H04W 24/10; H04W 56/0015

(57) ABSTRACT

Systems and methods which provide application aware network resource management. The method includes detecting, by a home application aware server, an issue with a home network meeting service requirements of an application accessed by a user on a mobile device, obtaining, by a home core network from the mobile device, wireless connectivity measurements from a secondary network that has overlapping wireless coverage with the home network, enabling, the mobile device to connect to the secondary network, when the secondary network can meet the service requirements, and re-connecting, the home network with the mobile device, when access to the application is completed.

### TECHNICAL FIELD

This disclosure relates to communications. More specifically, communications using a network based on application usage.

### BACKGROUND

In a given area, there is normally more than one network which can provide services to a mobile device. The services in the given area can be provided by multiple carriers, operators, and/or service providers (collectively “service providers”) which operate on different frequencies and/or use different technologies. Each service provider may provide different levels of service and/or network quality depending on business cases, load conditions, type of upper layer services, network architecture, and/or other configuration parameters. End users typically engage with one service provider to access services. This can be referred to as a home network. The end users use their mobile devices to access all types of applications and/or services. The end users will perceive different qualities of service depending on the application accessed and the capabilities of the network. Under certain conditions, it may be useful for the end user to access a different network even thought the home network is accessible by the end user.

### SUMMARY

Disclosed is a system and method for application aware network resource management. In implementations, method for providing application aware network resource management including detecting, by a home application aware server, an issue with a home network meeting service requirements of an application accessed by a user on a mobile device, obtaining, by a home core network from the mobile device, wireless connectivity measurements from a secondary network that has overlapping wireless coverage with the home network, enabling, the mobile device to connect to the secondary network, when the secondary network can meet the service requirements, and re-connecting, the home network with the mobile device, when access to the application is completed.

### BRIEF DESCRIPTION OF THE DRAWINGS

The disclosure is best understood from the following detailed description when read in conjunction with the accompanying drawings. It is emphasized that, according to common practice, the various features of the drawings are not to scale. On the contrary, the dimensions of the various features are arbitrarily expanded or reduced for clarity.

FIG. 1 is a diagram of an example of a communications architecture in accordance with the teachings described herein.

FIG. 2 is a diagram of an example of a geographic bin with network service parameters for a first network in accordance with the teachings described herein.

FIG. 3 is a diagram of an example of a geographic bin with network service parameters for a second network in accordance with the teachings described herein.

FIG. 4 is a diagram of an example of an end user attempting to access a first type of application.

FIG. 5 is a diagram of an example of an end user attempting to access a second type of application.

FIG. 6 is a flow diagram of an example flow for providing application aware network resource management in accordance with the teachings described herein.

FIG. 7 is a flowchart of an example method for providing application aware network resource management in accordance with the teachings described herein.

FIG. 8 is a flowchart of an example method for providing application aware network resource management in accordance with the teachings described herein.

FIG. 9 is a block diagram of an example of a device in accordance with the teachings described herein.

### DETAILED DESCRIPTION

Reference will now be made in greater detail to embodiments, examples of which are illustrated in the accompanying drawings. Wherever possible, the same reference numerals will be used throughout the drawings and the description to refer to the same or like parts.

As used herein, the terminology “server”, “computer”, “computing device or platform”, or “cloud computing system or platform” includes any unit, or combination of units, capable of performing any method, or any portion or portions thereof, disclosed herein. For example, the “server”, “computer”, “computing device or platform”, or “cloud computing system or platform” may include at least one or more processor(s).

As used herein, the terminology “processor” or “processing circuitry” indicates one or more processors, such as one or more special purpose processors, one or more digital signal processors, one or more microprocessors, one or more controllers, one or more microcontrollers, one or more application processors, one or more central processing units (CPU)s, one or more graphics processing units (GPU)s, one or more digital signal processors (DSP)s, one or more application specific integrated circuits (ASIC)s, one or more application specific standard products, one or more field programmable gate arrays, any other type or combination of integrated circuits, one or more state machines, or any combination thereof.

As used herein, the term “engine” may include software, hardware, or a combination of software and hardware. An engine may be implemented using software stored in the memory subsystem. Alternatively, an engine may be hard-wired into processing circuitry. In some cases, an engine includes a combination of software stored in the memory and hardware that is hard-wired into the processing circuitry.

As used herein, the terminology “memory” indicates any computer-usable or computer-readable medium or device that can tangibly contain, store, communicate, or transport any signal or information that may be used by or in connection with any processor. For example, a memory may be one or more read-only memories (ROM), one or more random access memories (RAM), one or more registers, low power double data rate (LPDDR) memories, one or more cache memories, one or more semiconductor memory devices, one or more magnetic media, one or more optical media, one or more magneto-optical media, or any combination thereof.

As used herein, the term “memory” includes one or more memories, where each memory may be a computer-readable medium. A memory may encompass memory hardware units (e.g., a hard drive or a disk) that store data or instructions in software form. Alternatively or in addition, the memory may include data or instructions that are hard-wired into processing circuitry. The memory may include a single memory unit or multiple joint or disjoint memory units, which each of the multiple joint or disjoint memory units storing all or a portion of the data described as being stored in the memory.

As used herein, the terminology “instructions” may include directions or expressions for performing any method, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, or combinations thereof, as described herein. For example, the memory can be non-transitory. Instructions, or a portion thereof, may be implemented as a special purpose processor, or circuitry, that may include specialized hardware for carrying out any of the methods, algorithms, aspects, or combinations thereof, as described herein. In some implementations, portions of the instructions may be distributed across multiple processors on a single device, on multiple devices, which may communicate directly or across a network such as a local area network, a wide area network, the Internet, or a combination thereof.

As used herein, the term “application” refers generally to a unit of executable software that implements or performs one or more functions, tasks, or activities. For example, applications may perform one or more functions including, but not limited to, telephony, web browsers, e-commerce transactions, media players, scheduling, management, smart home management, entertainment, and the like. The unit of executable software generally runs in a predetermined environment and/or a processor.

As used herein, the terminology “determine” and “identify,” or any variations thereof includes selecting, ascertaining, computing, looking up, receiving, determining, establishing, obtaining, or otherwise identifying or determining in any manner whatsoever using one or more of the devices and methods are shown and described herein.

As used herein, the terminology “example,” “the embodiment,” “implementation,” “aspect,” “feature,” or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “or” is intended to mean an inclusive “or” rather than an exclusive “or.” That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from the context to be directed to a singular form.

As used herein, unless explicitly stated otherwise, any term specified in the singular may include its plural version. For example, “a computer that stores data and runs software,” may include a single computer that stores data and runs software or two computers-a first computer that stores data and a second computer that runs software. Also “a computer that stores data and runs software,” may include multiple computers that together stored data and run software. At least one of the multiple computers stores data, and at least one of the multiple computers runs software.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure and claims. Although aspects, features, and elements are described herein in particular combinations, each aspect, feature, or element may be used independently or in various combinations with or without other aspects, features, and elements.

Further, the figures and descriptions provided herein may be simplified to illustrate aspects of the described teachings and/or embodiments that are relevant for a clear understanding of the herein disclosed processes, machines, and/or manufactures, while eliminating for the purpose of clarity other aspects that may be found in typical similar devices, systems, and methods. Those of ordinary skill may thus recognize that other elements and/or steps may be desirable or necessary to implement the devices, systems, and methods described herein. However, because such elements and steps do not facilitate a better understanding of the disclosed teachings and/or embodiments, a discussion of such elements and steps may not be provided herein. However, the present disclosure is deemed to inherently include all such elements, variations, and modifications to the described aspects that would be known to those of ordinary skill in the pertinent art in light of the discussion herein.

In a non-limiting example, assume that a first network can provide a 2 Mbps user bandwidth or access rate. If multiple end users are accessing an application and/or service in the first network that need more than 2 Mbps, then the end users will see poor network quality and/or will not be able to access such applications. The network capacity, coverage, interference along with number of users will impact end user services. Now assume that there is a second network which can provide a 10 Mbps user bandwidth or access rate. The second network, however, is providing service to fewer end users. In this scenario, the second network can afford to provide additional bandwidth to end users of the first network. This can enable each network to maintain the user quality. However, if too many end users of the first network are attempting to access the application, then the second network may suffer in network quality.

Described herein is a system and method for providing application aware network resource management. In implementations, the system and method can enable users to access secondary and/or non-home (collectively “secondary”) networks overlapping a home network when the user is attempting to access and/or use an application and/or service (collectively “application”) which has service and/or connectivity requirements which are and/or may be better served by the secondary network even though the home network is accessible. In this instance, the secondary network may provide one or more of better quality of service, less jitter, greater bandwidth rates, better block error rate (BLER), lower latency, better mean opinion score (MOS), better reference signal received power (RSRP), better signal-to-interference-plus-noise ratio (SINR) (collectively “network service parameters”), and/or combinations thereof than the home network.

In implementations, an application aware server can monitor and determine that an application being accessed by the user on the mobile device may not be adequately serviced by the home network. The home network can then trigger measurements for the secondary networks through neighbor radio base stations. After successful validation of the secondary network conditions along with supported applications and server load, a handover and/or network transition can be initiated. Once the user has completed usage of the application, the user and/or mobile device can switch back to the home network.

In implementations, the home network can request the mobile device to proactively make secondary network measurements before switching from the home network to the secondary network. In implementations, the mobile device can make primary synchronization signal (PSS) and secondary synchronization signal (SSS) measurements with respect to the secondary network.

In implementations, the system and methods described herein can provide efficient management of spectrum resources in any given geography by providing better quality and by sharing relevant resources. In implementations, service providers may increase revenue from sharing the resources.

In implementations, the system and methods described herein can provide enhanced user experience for any and/or all types of applications or use cases. In implementations, resource switching and/or sharing may positively impact users when, for example, a patient initiates a remote tele-based healthcare application on a home network with poor network connectivity.

In implementations, the system and methods described herein is transparent to the user and connections are seamless between the home network and the secondary network.

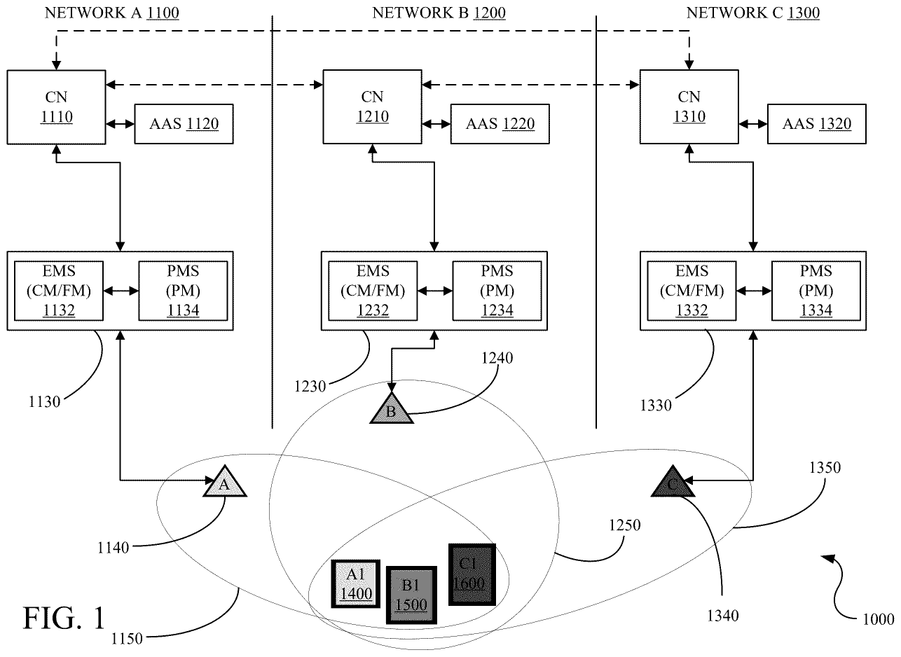

FIG. 1 is a diagram of an example of a communications architecture 1000 in accordance with the teachings described herein. The communications architecture 1000 can include, but is not limited to, a network A 1100, a network B 1200, and a network C 1300, which can provide services to mobile devices A1 1400, B1 1500, and C1 1600. The number of networks, mobile devices, and/or components shown herein are illustrative and there may be more or less in the communications architecture 1000. The communications architecture 1000 and the components therein may include other elements which may be desirable or necessary to implement the devices, systems, and methods described herein. However, because such elements and steps do not facilitate a better understanding of the disclosed teachings and/or embodiments, a discussion of such elements and steps may not be provided herein.

In implementations, the network A 1100 can be a home and/or primary network for the mobile device A1 1400 and a secondary network for the mobile devices B1 1500 and C1 1600. In implementations, the network B 1200 can be a home and/or primary network for the mobile device B1 1500 and a secondary network for the mobile devices A1 1400 and C1 1600. In implementations, the network C 1300 can be a home and/or primary network for the mobile device C1 1600 and a secondary network for the mobile devices A1 1400 and B1 1500.

In implementations, the network A 1100 can include, but is not limited to, a core network (CN) 1110, an application aware server (AAS) 1120, network management systems 1130, and one or more base stations 1140. The network management systems 1130 can include, but is not limited to, an element management system (EMS) 1132 and a performance management system (PMS) 1134.

In implementations, the network B 1200 can include, but is not limited to, a CN 1210, an AAS 1220, network management systems 1230, and one or more base stations 1240. The network management systems 1230 can include, but is not limited to, an EMS 1232 and a PMS 1234.

In implementations, the network C 1300 can include, but is not limited to, a CN 1310, an AAS 1320, network management systems 1330, and one or more base stations 1340. The network management systems 1330 can include, but is not limited to, an EMS 1332 and a PMS 1334.

In implementations, an CN, such as the CNs 1110, 1210, and 1310, can provide reliable access and connectivity to services for mobile devices. A CN can handle a range of essential functions in the respective networks, including but not limited to, connectivity and mobility management, authentication and authorization, subscriber data management, and policy management. In implementations, the CN can be implemented on service provider servers, a cloud computing platform, as an engine, and/or combinations thereof.

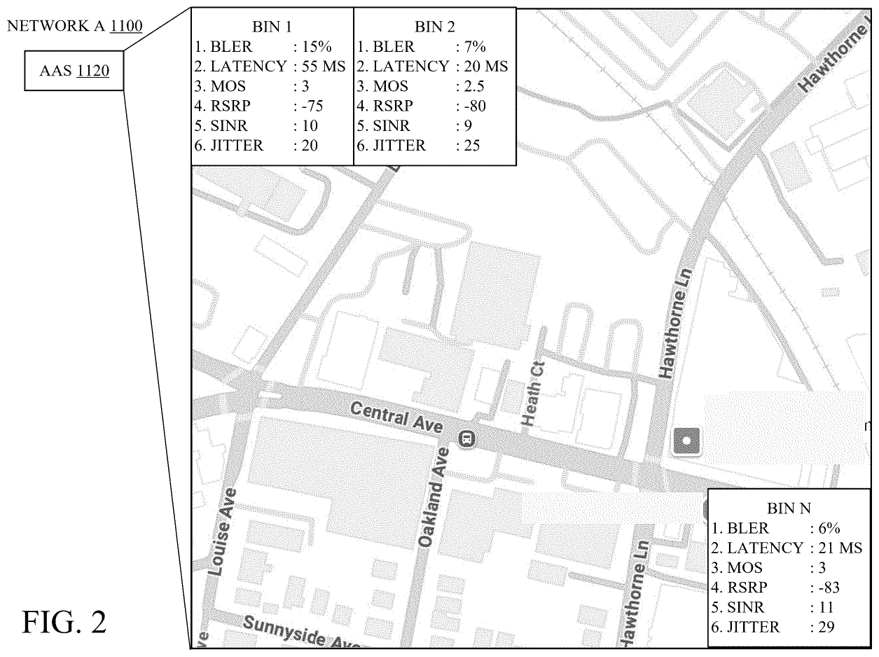

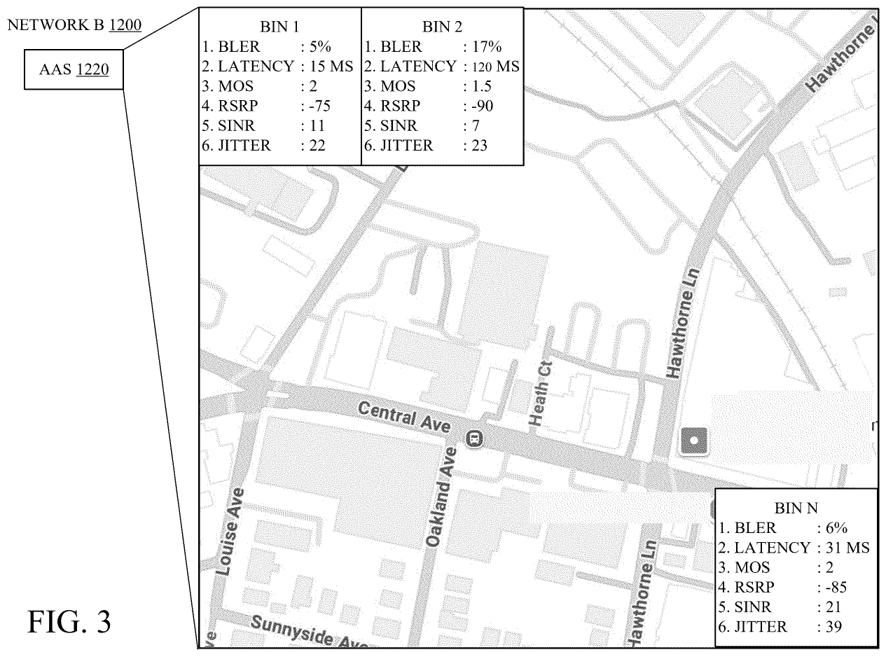

In implementations, an AAS, such as the AAS 1120, 1220, and 1320, can monitor service requirements for applications and use cases. The AAS can further monitor service level network quality per user per applications using one or more of the network service parameters, such as but not limited to, BLER, latency, data rate, and/or combinations thereof. The AAS can maintain network service parameters for their respective networks. In implementations, the AAS can maintain the network service parameters for a defined geographic bin of the network. FIG. 2 is a diagram of an example of a geographic bin with network service parameters for a first network in accordance with the teachings described herein and FIG. 3 is a diagram of an example of a geographic bin with network service parameters for a second network in accordance with the teachings described herein. In an illustrative non-limiting example, the first network is the network A 1100 and the second network is the network B 1200. The AAS' 1120 and 1220 can maintain a defined number of bins. Each bin can have a set of network service parameters representative of the quality of service in that bin. In implementations, the size or resolution of the bin can be 10×10 m², 50×50 m², 100×100 m², and/or other areas. In implementations, the shape of the bin can be any type of polygon.

In implementations, the network service parameters (also referred to as geographic-based network service parameters or geographic-binned network service parameters) can include, but is not limited to, quality of service, jitter, bandwidth rates, block error rate (BLER), latency, mean opinion score (MOS), reference signal received power (RSRP), signal-to-interference-plus-noise ratio (SINR), and/or combinations thereof. In implementations, the BLER can represent the percentage of data blocks received with errors. A higher BLER can mean more data errors, indicating poor channel quality. The BLER can be used to evaluate the overall reliability of data transmission. In implementations, the latency can refer to a measure of time taken for a data packet to travel across the network. It can be also defined as user plane (data) or control plane (signaling) latency. Higher latency means that the network is taking too much time to send or receive packets. This translates to poor network efficiency. In implementations, jitter is a measure of variation in the delay of data packet transmission and reception. It can cause packets to be received out of order. It can negatively impact audio, video, or data packet quality. In implementations, RSRP can measure the absolute power level of the received reference signal power from a cell tower. A better RSRP relates to good coverage (received power). It is the metric used to evaluate the overall reliability of data transmission. In implementations, SINR is used to evaluate the quality of the signal relative to background noise. A higher SINR indicates a clearer signal with less interference. It represents the ratio of the desired signal power to the combined power of interfering signal and noise. In implementations, MOS is the user perceived quality of a voice call.

In implementations, an EMS, such as the EMS 1132, 1232, and 1332, can manage one or more base stations, such as the one or more base stations 1140, 1240, and 1340, with respect to configuration and fault management. In addition, the EMS can perform event monitoring, alarms, parameter modification, and other functions for an associated network.

In implementations, an PMS, such as the PMS 1134, 1234, and 1334, can collect and store performance management data in a database. The PMS can maintain the history and performance records of each associated base station along with user/mobile device related data such as data rate, coverage, quality, connectivity, and/or other metrics in terms of statistics.

In implementations, a base station, such as the one or more base stations 1140, 1240, and 1340, can enable radio communications access and connectivity for the mobile devices in their respective networks. The base station can provide an air interface between the mobile device and the network. A base station can have a wireless coverage area, such as wireless coverage areas 1150, 1250, and 1350 associated with the one or more base stations 1140, 1240, and 1340, respectively. In implementations, the wireless coverage areas 1150, 1250, and 1350 can overlap such that a mobile device can have wireless coverage from a home network and secondary networks, as needed, for an application.

In implementations, a mobile device, such as mobile devices 1400, 1500, and 1600, can be a mobile device, an end user device, user equipment, Internet Protocol (IP) device, mobile computer, laptop, handheld computer, personal media device, smartphone, notebook, notepad, watch, augmented reality (AR)/ virtual reality (VR) headset, a device can access any applications through wireless network connectivity (voice or data), and/or the like, all of which can be provisioned for operation with the base station.

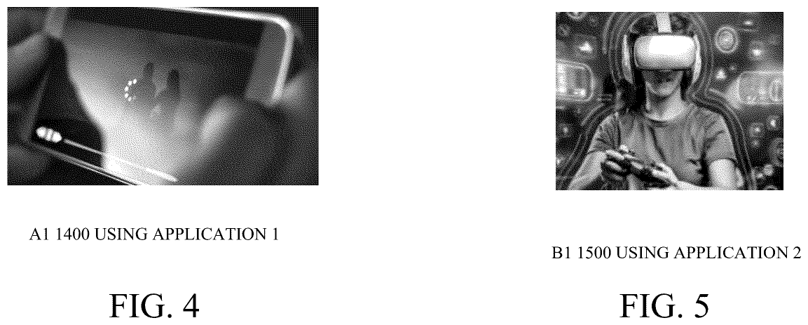

Operationally, in a non-limiting scenario for using the system and method described herein, assume that a user using the mobile device 1400 is attempting to use an application as shown in FIG. 4, which is a diagram of an example of an end user attempting to access a first type of application. In this instance, the application requires a high data rate network (e.g., greater than 10 Mbps). Further assume that a user using the mobile device 1500 is attempting to use an application as shown in FIG. 5, which is a diagram of an example of an end user attempting to access a second type of application. In this instance, the application requires a low latency network (e.g., latency less than 50 ms). In a traditional architecture, the users are subscribed to individual networks (i.e., a home network) and can't change the situation in terms of accessibility (i.e., can't change networks) while continuing accessing the home network.

However, in the system and method described herein, the home network AAS can detect the service requirements of the application being accessed and/or used by the user with the mobile device. The home network AAS can determine that the home network of the user is unable to provide and/or meet the service requirements. The home network AAS can instruct and/or trigger the home network CN to trigger a potential handoff to a secondary network, where the secondary network has overlapping wireless coverage with the home network in the region and/or location that the mobile device is operating when accessing the application.

The home network CN can trigger the mobile device to take measurements with respect to a base station associated with the secondary network. The mobile device can make PSS and SSS measurements to determine a signal strength of the secondary network at the mobile device location. This measurement is done proactively before initiating a handoff to the secondary network to avoid ping-ponging between the home network and the secondary network. The home network CN can then send the service requirements of the application and mobile device to the secondary network CN. The home network CN can request geographically-binned network service parameters from the secondary network AAS via the secondary network CN. If the geographically-binned network service parameters are acceptable and the secondary network can handle the service requirements of the mobile device, then the mobile device is handed off to the secondary network using methods known to one of ordinary skill in the art. Once the user completes usage of the application, the mobile device is transferred back to the home network using methods known to one of ordinary skill in the art.

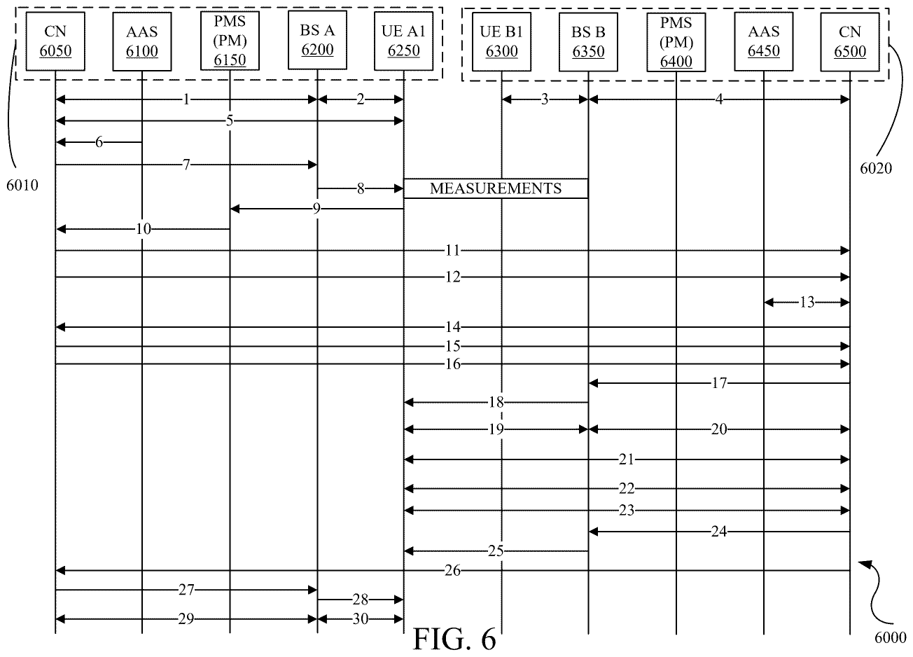

FIG. 6 is a flow diagram of an example flow 6000 for providing application aware network resource management in accordance with the teachings described herein. In implementations, the flow 6000 may be implemented using a CN 6050, an AAS 6100, a PMS 6150, a BS A 6200, a UE A1 6250, a UE B1 6300, a BS B 6350, a PMS 6400, an AAS 6450, and a CN 6500. The CN 6050, the AAS 6100, the PMS 6150, the BS A 6200, and the UE A1 6250 can be associated with a network A 6010. The UE B1 6300, the BS B 6350, the PMS 6400, the AAS 6450, and the CN 6500 can be associated with a network B 6020. In addition to the description herein, the components described herein can also include the descriptions stated herein with respect to FIGS. 1-5 and 7-9. The number of components shown herein are illustrative and there may be more or less in the flow 6000. The flow 6000 and the components therein may include other elements which may be desirable or necessary to implement the devices, systems, and methods described herein. However, because such elements and steps do not facilitate a better understanding of the disclosed teachings and/or embodiments, a discussion of such elements and steps may not be provided herein.

At (1) and (2), the UE A1 6250 can be deemed to be in communications with the CN 6050 and the BS A 6200. At (3) and (4), the UE B1 6300 can be deemed to be in communications with the CN 6500 and the BS B 6350. At (5), the UE A1 6250 attempts to access an application 1 which has defined service requirements. In a non-limiting illustration, the defined service requirements can include, but is not limited to, latency, BLER, jitter, rate, and/or combinations thereof. At (6), the AAS 6100, which is monitoring access on the network A 6010, detects that the network A 6010 is unable to meet the defined service requirements. The AAS 6100 can request and/or trigger the CN 6050 to find a secondary network.

At (7), the CN 6050 can trigger and/or notify the base station to add the secondary network. At (8), the BS A 6200 can trigger the UE A1 6250 to make measurements with respect to the BS B 6350. The measurements can be PSS and SSS measurements, which can be made a center frequency and/or bandwidth of the BS B 6350. The PSS and SSS measurement can be used to determine a physical cell identity (PCI) of the BS B 6350 and/or the network B 6020 and a signal strength associated with the BS B 6350 and/or the network B 6020. These measurements can ensure that the UE A1 6250 does not bounce between the network A 6010 and the network B 6020 due to weak signal strength. At (9), the UE A1 6250 can send the measurements to the PMS 6400. If the measurements are acceptable, at (10), the PMS 6400 can notify the CN 6050 to move forward with the handover and/or switchover to the BS B 6350 and/or the network B 6020.

At (11), the CN 6050 can provide the service requirements of the application, the acceptable loading conditions for a transfer, and the quality of service requirements of the UE A1 6250 to the CN 6500. In addition, at (12), the CN 6050 can request the geographic specific network service parameters from existing users, a historical database, and/or combinations thereof. At (13), the CN 6500 can notify and/or instruct the AAS 6450 to supply the requested information. At (14), the CN 6500 can provide the requested geographic specific network service parameters to the CN 6050. At (15), the CN 6500 can notify the CN 6050 that the transfer is acceptable. If the CN 6050 and/or AAS 6100 determines that the geographic specific network service parameters are acceptable, then at (16), the CN 6050 can initiate the authentication process with the CN 6500.

At (17), the CN 6500 can permit the UE A1 6250 to connect to the BS B 6350 and/or the network B 6020 and trigger the BS B 6350 appropriately. At (18), the BS B 6350 can trigger connection measurements with the UE A1 6250. At (19) and (20), resources can be allocated and a connection established between the UE A1 6250 and the BS B 6350 and/or the CN 6500. At (21), the UE A1 6250 can access the application over and/or using the network B 6020 connection. At (22), the PMS 6400 and the AAS 6450 can monitor network performance, quality of service, and whether the UE A1 6250 is still accessing the application that triggered the initial transfer.

At (23), the UE A1 6250 has completed usage of the application. In implementations, this is detected by the AAS 6450. At (24), the CN 6500 can initiate release of the resources to the BS B 6350, which in turn, at (25), can notify the UE A1 6250. At (26), the CN 6500 can notify the CN 6050 that access of the application by the UE A1 6250 is complete and that the resources are being released. At (27), the CN 6050 can re-initiate a network connection with the UE A1 6250 by informing the BS A 6200. At (28), the BS A 6200 can allocate resources to the UE A1 6250. At (29) and (30, the connection is re-established between the UE A1 6250 and the BS A 6200 and/or the CN 6050.

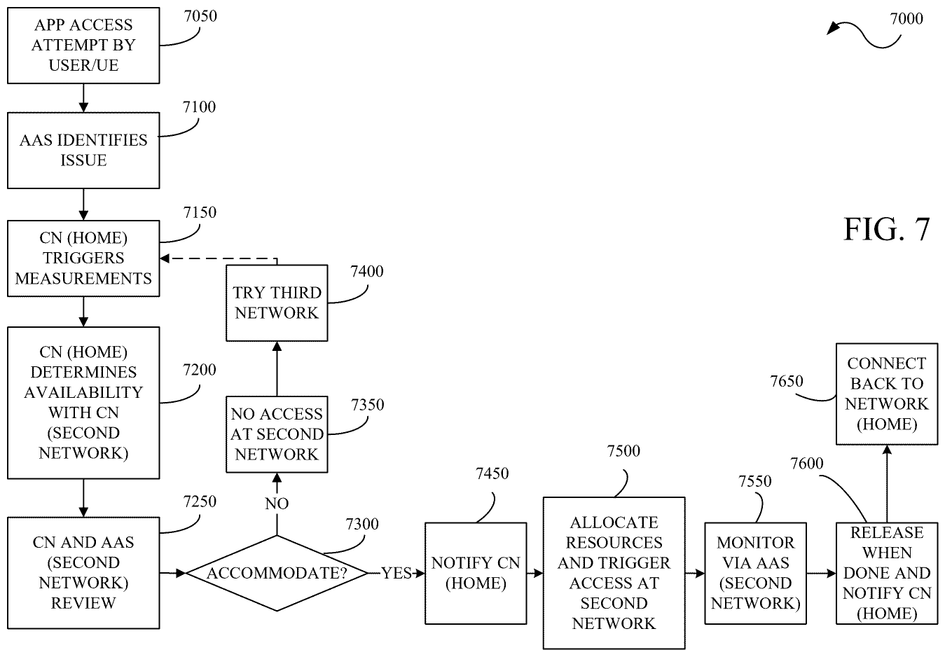

FIG. 7 is a flowchart of an example method 7000 for providing application aware network resource management in accordance with the teachings described herein. A user has a mobile device and subscribes to wireless connectivity services on a home network for network and internet access. At 7050, the user attempts to access an application on the mobile device. The application has one or more defined service requirements. At 7100, a home AAS can determine that the home network's network service parameters do not meet the applications'service requirement(s). The home AAS can notify the home CN of the issue and/or problem.

At 7150, the home CN can identify accessible secondary networks. The accessible secondary networks are networks that have overlapping wireless coverage areas with the home network. The home CN can trigger the mobile device to obtain measurements of available frequencies and/or channels with a secondary network base station. These measurements can include, but are not limited to, PSS and SSS measurements.

At 7200, the home CN can connect to the secondary CN. The home CN can send information to the secondary CN such as, but not limited to, the service requirements of the mobile device. The home CN can request information from the secondary CN such as, but not limited to, geographic-based network service parameters, available bandwidth, available services, and/or combinations thereof. The home CN can review the information received from the secondary CN. In implementations, the home CN can review the information with the home AAS.

At 7250, the secondary CN and the secondary AAS can review the information received from the home CN. At 7300, the secondary CN can decide as to whether the secondary network can accommodate the mobile device.

If an accommodation is not possible, then at 7350, the secondary CN can inform the home CN. At 7400, the home CN can search for another secondary network. The process would start over at 7150.

If an accommodation is possible, then at 7450, the secondary CN can notify the home CN that a transfer is possible. The home CN can notify the secondary CN to initiate the transfer. At 7500, the secondary CN can allocate the resources and trigger access at the secondary network for the mobile device. The mobile device can then access the secondary network and access the application. At 7550, the secondary AAS and other secondary components can monitor secondary network performance and mobile device activity, quality of service, and/or other metrics. At 7600, the secondary CN can release resources and notify the home CN when the mobile device has completed using the application. The secondary CN can send quality of service metrics, usage time, and/or other metrics. In a non-limiting illustration, these metrics can be used for compensation determinations. At 7650, the home CN can re-connect the mobile device to the home network.

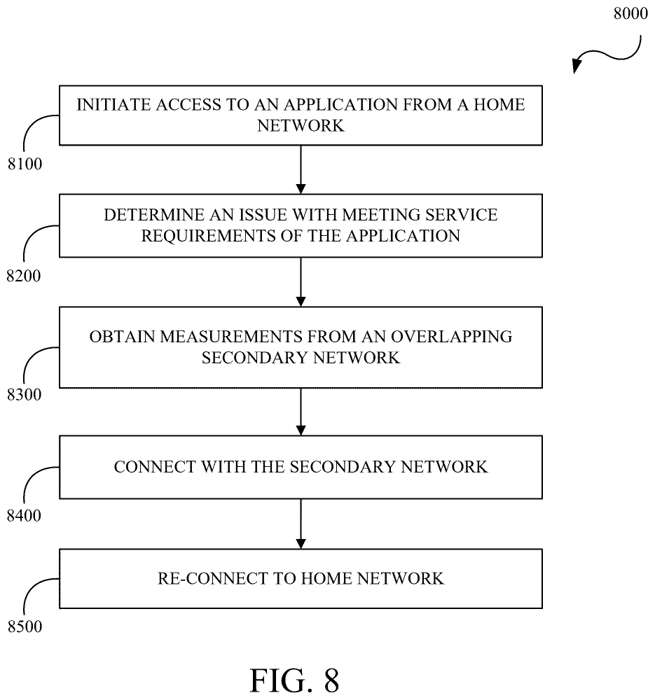

FIG. 8 is a flowchart of an example method 8000 for providing application aware network resource management in accordance with the teachings described herein. The method 8000 includes: initiating 8100 access to an application on a mobile device from a home network; determining 8200 an issue with meeting service requirements of the application by the home network; obtaining 8300 measurements from a secondary network that has overlapping coverage with the home network; connecting 8400 with the secondary network when the secondary network can meet the service requirements; and re-connecting 8500 with the home network when access with the application is finished. The method 8000 can be implemented, for example, in or by components described with respect to FIGS. 1-6 and 9 in conjunction with any of the flows described with respect to FIGS. 6-7, as appropriate and applicable.

The method 8000 includes initiating 8100 access to an application on a mobile device from a home network. A user can use a mobile device to access applications and services. The user can subscribe with a home network for connectivity. The applications and/or services can have service requirements for functional operability in terms of one or more network service parameters. That is, some applications need low latency, some need high bandwidth rates, some need low BLER, and/or combinations thereof.

The method 8000 includes determining 8200 an issue with meeting service requirements of the application by the home network. A home AAS can detect that a mobile device is using an application that had defined service requirements. The AAD can determine whether the home network (on a geographic bin basis) can meet the service requirements. If the service requirements cannot be met by the home network, the home AAS can notify the home CN, which in turn can search for overlapping secondary networks that can meet the service requirements.

The method 8000 includes obtaining 8300 measurements from a secondary network that has overlapping coverage with the home network. The home CN can trigger the mobile device to obtain measurements, such as wireless connectivity measurements, from the overlapping secondary network. The wireless connectivity measurements can include PSS and SSS measurements. These are obtained to prevent connecting the mobile device to a secondary network that does not have sufficient signal strength to support the mobile device. The home CN can review the measurements and if useable, connect with secondary CN to transfer information about the service requirements, load conditions, resource availability, geographic-based network service parameters, and/or information.

The method 8000 includes connecting 8400 with the secondary network when the secondary network can meet the service requirements. The secondary CN can authorize and allocate resources for the mobile device to connect to the secondary network assuming both the home CN and the secondary CN have approved the transfer. That is, the home CN can enable the mobile device to connect to the secondary network. The secondary AAS can monitor the performance of the mobile device and the meeting of the service requirements by the second network.

The method 8000 includes re-connecting 8500 with the home network when access with the application is finished. Once the user has completed using the application, the secondary CN can notify the home network and release the allocated resources. The mobile device can re-connect with the home network.

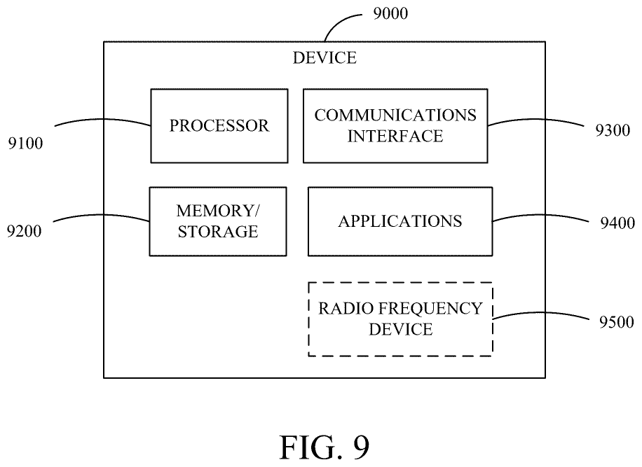

FIG. 9 is a block diagram of an example of a device 9000 in accordance with the teachings described herein. The device 9000 may include, but is not limited to, a processor 9100, a memory/storage 9200, a communication interface 9300, applications 9400, and, if needed, a radio frequency device 9500. The device 9000 may include or implement, for example, the systems and components described with respect to FIGS. 1-6 and the implement the methods of FIGS. 6-8. The applicable or appropriate flows, techniques, or methods described herein may be stored in the memory/storage 9200 and executed by the processor 9100 in cooperation with the memory/storage 9200, the communications interface 9300, the applications 9400, and the radio frequency device 9500 (when applicable), as appropriate. The device 9000 may include other elements which may be desirable or necessary to implement the devices, systems, and methods described herein. However, because such elements and steps do not facilitate a better understanding of the disclosed embodiments, a discussion of such elements and steps may not be provided herein.

Described is a method for application aware network resource management. In implementations, the method includes detecting, by a home application aware server, an issue with a home network meeting service requirements of an application accessed by a user on a mobile device, obtaining, by a home core network from the mobile device, wireless connectivity measurements from a secondary network that has overlapping wireless coverage with the home network, enabling, the mobile device to connect to the secondary network, when the secondary network can meet the service requirements, and re-connecting, the home network with the mobile device, when access to the application is completed.

In implementations, the mobile device is subscribed with the home network for wireless connectivity services. In implementations, the detecting further includes checking, by the home application aware server, the service requirements against geographic-based network service parameters of the home network to determine whether the home network can meet the service requirements. In implementations, the geographic-based network service parameters include at least one of jitter, block error rate, latency, mean opinion score, reference signal received power, and signal-to-interference-plus-noise ratio. In implementations, the method further includes searching, by the home core network, for secondary networks which have overlapping wireless coverage with the home network. In implementations, the wireless connectivity measurements include primary synchronization signal (PSS) measurements and secondary synchronization signal (SSS) measurements. In implementations, the method further includes connecting, by the home core network with a secondary core network, to exchange the service requirements, resource availability, and geographic-based network service parameters of the secondary network. In implementations, the geographic-based network service parameters include at least one of jitter, block error rate, latency, mean opinion score, reference signal received power, and signal-to-interference-plus-noise ratio. In implementations, the connecting further includes enabling, the mobile device to connect to the secondary network, when the secondary network can meet the service requirements and the secondary network has resources available for the mobile device. In implementations, the method further includes enabling, the mobile device to receive from the secondary core network, resources to connect to the secondary network. In implementations, the method further includes enabling, the mobile device to receive from the secondary core network, authorization to connect to the secondary network.

Described is a network for application aware network resource management. In implementations, the network includes an application aware server configured to determine that the network is unable to meet connectivity requirements of a service accessed by a user on a mobile device that operates on the network, and a core network connected to the application aware server. The core network configured to request measurements from another network which has wireless coverage that overlaps with a wireless coverage of the network, initiate connection of the mobile device to the another network when the another network confirms support of the connectivity requirements, and re-establish connections with the mobile device when usage of the services is finished.

In implementations, the application aware server is further configured to compare the connectivity requirements against geographic-binned network service parameters of the network to determine whether the network can support the connectivity requirements. In implementations, the geographic-based network service parameters include at least one of jitter, block error rate, latency, mean opinion score, reference signal received power, and signal-to-interference-plus-noise ratio. In implementations, the core network is configured to locate secondary networks which overlap the wireless coverage of the network. In implementations, the measurements include primary synchronization signal (PSS) measurements and secondary synchronization signal (SSS) measurements. In implementations, the core network is configured to connect to a core network of the secondary network to exchange the connectivity requirements, resource availability, and geographic-binned network service parameters of the secondary network, wherein the geographic-based network service parameters include at least one of jitter, block error rate, latency, mean opinion score, reference signal received power, and signal-to-interference-plus-noise ratio. In implementations, the core network is configured to initiate the connection of the mobile device to the another network when the another network confirms support of the connectivity requirements and can allocate connection resources.

Described is a method for application aware network resource management. In implementations, the method includes determining, by an application aware engine, that a network is unable to meet connectivity requirements of a service accessed by a user on a mobile device that operates on the network, requesting, by a core network, measurements from another network which has overlapping wireless coverage with the network, initiating, by the core network, connection of the mobile device to the another network when the another network confirms support of the connectivity requirements and has available resources, and re-establishing, by the core network, connections with the mobile device when usage of the services is finished.

In implementations, the determining further comprising comparing, by the application aware engine, the connectivity requirements against geographic-binned network service parameters of the network to determine whether the network can support the connectivity requirements. In implementations, the measurements include primary synchronization signal (PSS) measurements and secondary synchronization signal (SSS) measurements. In implementations, the method further including connecting, by the core network with the other network, to review the service requirements, resource availability, and geographic-based network service parameters of the other network, enabling, the mobile device to receive from the other network, resources to connect to the other network, and enabling, the mobile device to receive from the other network, authorization to connect to the other network.

Although some teachings and/or embodiments herein refer to methods, it will be appreciated by one skilled in the art that they may also be embodied as a system or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “processor,” “device,” or “system.” Furthermore, aspects may take the form of a computer program product embodied in one or more the computer readable mediums having the computer readable program code embodied thereon. For example, the computer readable mediums can be non-transitory. Any combination of one or more computer readable mediums may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to CDs, DVDs, wireless, wireline, optical fiber cable, RF, etc., or any suitable combination of the foregoing.

As used herein, the term “computer-readable medium” encompasses one or more computer-readable media. A computer-readable medium may include any storage unit (or multiple storage units) that store data or instructions that are readable by processing circuitry. A computer-readable medium may include, for example, at least one of a data repository, a data storage unit, a computer memory, a hard drive, a disk, or a random access memory. A computer-readable medium may include a single computer-readable medium or multiple computer-readable media. A computer-readable medium may be a transitory computer-readable medium or a non-transitory computer-readable medium.

Computer program code for carrying out operations for aspects may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects are described herein with reference to flowchart illustrations and/or block diagrams of methods, apparatus (systems) and computer program products according to teachings and/or embodiments. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the figures illustrate the architecture, functionality, and operation of possible implementations of systems, methods, and computer program products according to various teachings and/or embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures.

While the disclosure has been described in connection with certain teachings and/or embodiments, it is to be understood that the disclosure is not to be limited to the disclosed teachings and/or embodiments but, on the contrary, is intended to cover various modifications, combinations, and equivalent arrangements included within the scope of the appended claims, which scope is to be accorded the broadest interpretation so as to encompass all such modifications and equivalent structures as is permitted under the law.

What is claimed is:

1. A method for providing application aware network resource management, the method comprising:
detecting, by a home application aware server, that a home network does not meet service requirements of an application accessed by a user on a mobile device;
obtaining, by a home core network, wireless connectivity measurements from a secondary network that has overlapping wireless coverage with the home network;
enabling the mobile device to connect to the secondary network when the secondary network can meet the service requirements; and
re-connecting the home network with the mobile device when access to the application is completed.

2. The method of claim 1, wherein the mobile device is subscribed with the home network for wireless connectivity services.

3. The method of claim 1, wherein the detecting further comprising:
checking, by the home application aware server, the service requirements against geographic-based network service parameters of the home network to determine whether the home network can meet the service requirements.

4. The method of claim 3, wherein the geographic-based network service parameters include at least one of jitter, block error rate, latency, mean opinion score, reference signal received power, and signal-to-interference-plus-noise ratio.

5. The method of claim 1, further comprising:
searching, by the home core network, for secondary networks which have overlapping wireless coverage with the home network.

6. The method of claim 1, wherein the wireless connectivity measurements include primary synchronization signal (PSS) measurements and secondary synchronization signal (SSS) measurements.

7. The method of claim 1, further comprising:
connecting, by the home core network with a secondary core network, to exchange the service requirements, resource availability, and geographic-based network service parameters of the secondary network.

8. The method of claim 7, wherein the geographic-based network service parameters include at least one of jitter, block error rate, latency, mean opinion score, reference signal received power, and signal-to-interference-plus-noise ratio.

9. The method of claim 1, wherein the connecting further comprising:
enabling the mobile device to connect to the secondary network when the secondary network can meet the service requirements and the secondary network has resources available for the mobile device.

10. The method of claim 1, further comprising:
enabling, the mobile device to receive from the secondary network, resources to connect to the secondary network.

11. The method of claim 1, further comprising:
enabling, the mobile device to receive from the secondary network, authorization to connect to the secondary network.

12. A network, comprising:
an application aware server configured to determine that the network is unable to meet connectivity requirements of a service accessed by a user on a mobile device that operates on the network; and
a core network connected to the application aware server, the core network configured to:
request measurements from another network which has wireless coverage that overlaps with a wireless coverage of the network;
initiate connection of the mobile device to the another network when the another network confirms support of the connectivity requirements; and
re-establish connections with the mobile device when usage of the services is finished.

13. The network of claim 12, wherein the application aware server is further configured to:
compare the connectivity requirements against geographic-binned network service parameters of the network to determine whether the network can support the connectivity requirements.

14. The network of claim 13, wherein the geographic-binned network service parameters include at least one of jitter, block error rate, latency, mean opinion score, reference signal received power, and signal-to-interference-plus-noise ratio.

15. The network of claim 12, wherein the core network is further configured to:
locate secondary networks which overlap the wireless coverage of the network.

16. The network of claim 12, wherein the measurements include primary synchronization signal (PSS) measurements and secondary synchronization signal (SSS) measurements.

17. The network of claim 12, wherein the core network is further configured to:
connect to a core network of the another network to exchange the connectivity requirements, resource availability, and geographic-binned network service parameters of the another network, wherein the geographic-binned network service parameters include at least one of jitter, block error rate, latency, mean opinion score, reference signal received power, and signal-to-interference-plus-noise ratio.

18. The network of claim 12, wherein the core network is further configured to:
initiate the connection of the mobile device to the another network when the another network confirms support of the connectivity requirements and can allocate connection resources.

19. A method for providing application aware network resource management, the method comprising:
determining, by an application aware engine, that a network is unable to meet connectivity requirements of a service accessed by a user on a mobile device that operates on the network;
requesting, by a core network, measurements from another network which has overlapping wireless coverage with the network;
initiating, by the core network, connection of the mobile device to the another network when the another network confirms support of the connectivity requirements and has available resources; and
re-establishing, by the core network, connections with the mobile device when usage of the services is finished.

20. The method of claim 19, wherein the determining further comprising:
comparing, by the application aware engine, the connectivity requirements against geographic-binned network service parameters of the network to determine whether the network can support the connectivity requirements.

21. The method of claim 19, wherein the measurements include primary synchronization signal (PSS) measurements and secondary synchronization signal (SSS) measurements.

22. The method of claim 19, further comprising:
connecting, by the core network with the other network, to review the service requirements, resource availability, and geographic-based network service parameters of the other network;
enabling, the mobile device to receive from the other network, resources to connect to the other network; and
enabling, the mobile device to receive from the other network, authorization to connect to the other network.
